(19) United States
(12) Patent Application Publication
(10) Pub. No.: US 2026/0160884 A1
(43) Pub. Date: Jun. 11, 2026

(54) DYNAMIC AGGREGATION DURATION FOR A VEHICLE-BASED RADAR POINT CLOUD

(71) Applicant: GM GLOBAL TECHNOLOGY OPERATIONS LLC, DETROIT, MI (US)

(72) Inventors: Yuval Haitman, Ramat-Gan (IL); Oded Bialer, Petach Tikva (IL)

(21) Appl. No.: 18/971,272

(22) Filed: Dec. 6, 2024

(51) Int. Cl. G01S 13/89; G01S 13/931

(52) U.S. Cl. CPC G01S 13/89; G01S 13/931

(57) ABSTRACT

Examples described herein provide a method that includes detecting, using a radar device of a vehicle, a reflection point on a target object and determining a dynamic aggregation duration for aggregating radar data for the reflection point, the dynamic aggregation duration being a period of time specific to the reflection point and being based at least in part on a radial velocity of the reflection point, a reflection point angle of the reflection point, and a distribution of a heading direction for the reflection point. The method further includes aggregating the radar data of the target object for the period of time specific to the reflection point as defined by the dynamic aggregation duration. The method further includes performing a perception task using the aggregated radar data of the target object aggregated for the period of time specific to the reflection point as defined by the dynamic aggregation duration.

### BACKGROUND

The subject disclosure relates to vehicles, and in particular to dynamic aggregation duration for a vehicle-based radar point cloud.

Modern vehicles (e.g., a car, a motorcycle, a boat, or any other type of automobile) may be equipped with one or more cameras that provide back-up assistance, take images of the vehicle driver to determine driver drowsiness or attentiveness, provide images of the road as the vehicle is traveling for collision avoidance purposes, provide structure recognition (e.g., roadway signs, etc.), and/or the like, including combinations and/or multiples thereof. For example, a vehicle can be equipped with multiple cameras, and images from multiple cameras (referred to as “surround view cameras”) can be used to create a “surround” or “bird's eye” view of the vehicle. Some of the cameras (referred to as “long-range cameras”) can be used to capture long-range images (e.g., for object detection for collision avoidance, structure recognition, etc.).

Such vehicles can also be equipped with sensors such as a radar device(s), lidar device(s), and/or the like for perception tasks. Radar (radio detection and ranging) is a technology that uses radio waves to detect and determine the distance, speed, and angle of objects. Radar works by emitting radio signals that bounce off objects and return to the radar system, where the reflected waves are analyzed based on the amount of time between emission and reception. The measured time can be used to determine the distance between the radar device and the detected object, which can be used when performing perception tasks.

Perception tasks can include one or more of object detection, classification, tracking, lane detection, road sign recognition, and obstacle avoidance. Perception tasks are particularly useful for an autonomous vehicle to provide the autonomous vehicle with real-time awareness of its environment to make safe and informed driving decisions. Images from the one or more cameras of the vehicle can also be used for detecting objects, tracking targets, and/or the like, including combinations and/or multiples thereof.

The desire for precise object detection remains for applications, such as autonomous driving, where real-time awareness of the environment is important for safe navigation.

### SUMMARY

In one embodiment, a computer-implemented method is provided. The method includes detecting, using a radar device of a vehicle, a reflection point on a target object. The method further includes determining a dynamic aggregation duration for aggregating radar data for the reflection point, the dynamic aggregation duration being a period of time specific to the reflection point, wherein the dynamic aggregation duration is based at least in part on a radial velocity of the reflection point, a reflection point angle of the reflection point, and a distribution of a heading direction for the reflection point. The method further includes aggregating the radar data, as aggregated radar data, of the target object for the period of time specific to the reflection point as defined by the dynamic aggregation duration. The method further includes performing a perception task using the aggregated radar data of the target object aggregated for the period of time specific to the reflection point as defined by the dynamic aggregation duration.

In addition to one or more of the features described herein, or as an alternative, further embodiments of the method may include autonomously driving the vehicle based at least in part on a result of the perception task.

In addition to one or more of the features described herein, or as an alternative, further embodiments of the method may include that determining the dynamic aggregation duration includes determining a position offset, the position offset being an offset between a true position of the reflection point if shifted from a past point in time to a present point in time with a true velocity vector and the position of a predicted position of the reflection point when shifted according to the radial velocity of the reflection point, setting a limit to the position offset, deriving a limited aggregation time per reflection point based on the limit and depending on the radial velocity of the reflection point, the reflection point angle of the reflection point, and a heading direction distribution, and deriving the aggregation duration of each reflection point based on its limit.

In addition to one or more of the features described herein, or as an alternative, further embodiments of the method may include that the dynamic aggregation duration is based on a Laplacian distribution, the Laplacian distribution being the heading direction distribution of the reflection point.

In addition to one or more of the features described herein, or as an alternative, further embodiments of the method may include that the position offset is determined using the following equation:

$$\frac{{v}_{r} T}{cos ( θ + α )}$$

where vᵣ is a velocity of the reflection point, T is an aggregation time, θ is a reflection point angle of the reflection point relative to the radar device, and a is a reflection point heading of the reflection point relative to the radar device.

In addition to one or more of the features described herein, or as an alternative, further embodiments of the method may include that the position offset is determined using the following equation:

$$\frac{{v}_{r} T}{cos ( θ + α )} sin ( θ + α ) = T {v}_{r} tan ( θ + α )$$

where vᵣ is a velocity of the reflection point, T is an aggregation time, θ is a reflection point angle of the reflection point relative to the radar device, and α is a reflection point heading of the reflection point relative to the radar device.

In addition to one or more of the features described herein, or as an alternative, further embodiments of the method may include that the limit to the position offset is determined using the following equation:

$$\frac{\vert {v}_{r} \vert T}{cos ( θ + α )} < D$$

where vᵣ is a velocity of the reflection point, T is an aggregation time, θ is a reflection point angle of the reflection point relative to the radar device, α is a reflection point heading of the reflection point relative to the radar device, and D is the limit.

In addition to one or more of the features described herein, or as an alternative, further embodiments of the method may include that the limit to the position offset is determined using the following equation:

$$T \vert {v}_{r} \vert tan ( θ + α ) < D$$

where vᵣ is a velocity of the reflection point, T is an aggregation time, θ is a reflection point angle of the reflection point relative to the radar device, α is a reflection point heading of the reflection point relative to the radar device, and D is the limit.

In addition to one or more of the features described herein, or as an alternative, further embodiments of the method may include that the limited aggregation time is derived using the following equation:

$$T < \frac{D cos ( θ + α )}{\vert {v}_{r} \vert}$$

where vᵣ is a velocity of the reflection point, T is an aggregation time, θ is a reflection point angle of the reflection point relative to the radar device, α is a reflection point heading of the reflection point relative to the radar device, and D is the limit.

In addition to one or more of the features described herein, or as an alternative, further embodiments of the method may include that the limited aggregation time is derived using the following equation:

$$T < \frac{D}{\vert {v}_{r} \vert tan ( θ + α )}$$

where vᵣ is a velocity of the reflection point, T is an aggregation time, θ is a reflection point angle of the reflection point relative to the radar device, α is a reflection point heading of the reflection point relative to the radar device, and D is the limit.

In addition to one or more of the features described herein, or as an alternative, further embodiments of the method may include that the dynamic aggregation duration is derived using the following equation:

$$T < {E}_{α} \{ \frac{D cos ( θ + α )}{\vert {v}_{r} \vert} \} = {\int }_{α = - π / 2}^{π / 2} \frac{D cos ( θ + α )}{\vert {v}_{r} \vert} {p}_{r} ( α ) d α = \frac{D}{\vert {v}_{r} \vert} cos ( θ ) {L}_{1} - \frac{D}{\vert {v}_{r} \vert} sin ( θ ) {L}_{2}$$

where T is an aggregation time, E_{α} is the expectation with respect to α, D is a limit to the position offset, θ is a reflection point angle of the reflection point relative to the radar device, α is a reflection point heading of the reflection point relative to the radar device, vᵣ is a velocity of the reflection point, pᵣ is a probability distribution function, L₁ is defined by the following equation:

$${L}_{1} = {\int }_{α = - π / 2}^{π / 2} cos ( α ) {p}_{r} ( α ) d α ,$$

and L₂ is defined by the following equation:

$${L}_{2} = {\int }_{α = - \frac{π}{2}}^{\frac{π}{2}} sin ( α ) {p}_{r} ( α ) d α .$$

In addition to one or more of the features described herein, or as an alternative, further embodiments of the method may include that the dynamic aggregation duration is derived using the following equation:

$$T < {E}_{α} \{ \frac{D}{\vert {v}_{r} \vert tan ( θ + α )} \} = {\int }_{α = - π / 2}^{π / 2} \frac{D}{\vert {v}_{r} \vert tan ( θ + α )} {p}_{r} ( α ) d α$$

where T is an aggregation time, E_{α} is the expectation with respect to α, D is a limit to the position offset, θ is a reflection point angle of the reflection point relative to the radar device, α is a reflection point heading of the reflection point relative to the radar device, vᵣ is a velocity of the reflection point, and pᵣ is a probability distribution function.

In another embodiment, a vehicle is provided. The vehicle includes a radar device and a processing system including a memory having computer readable instructions and a processing device for executing the computer readable instructions. The computer readable instructions control the processing system to perform operations including detecting, using the radar device of the vehicle, a reflection point on a target object, determining a dynamic aggregation duration for aggregating radar data for the reflection point, the dynamic aggregation duration being a period of time specific to the reflection point, wherein the dynamic aggregation duration is based at least in part on a radial velocity of the reflection point, a reflection point angle of the reflection point, and a distribution of a heading direction for the reflection point, aggregating the radar data, as aggregated radar data, of the target object for the period of time specific to the reflection point as defined by the dynamic aggregation duration, and performing a perception task using the aggregated radar data of the target object aggregated for the period of time specific to the reflection point as defined by the dynamic aggregation duration.

In addition to one or more of the features described herein, or as an alternative, further embodiments of the vehicle may include that the operations further include autonomously driving the vehicle based at least in part on a result of the perception task.

In addition to one or more of the features described herein, or as an alternative, further embodiments of the vehicle may include that determining the dynamic aggregation duration includes determining a position offset, the position offset being an offset between a true position of the reflection point if shifted from a past point in time to a present point in time with a true velocity vector and the position of a predicted position of the reflection point when shifted according to the radial velocity of the reflection point.

In addition to one or more of the features described herein, or as an alternative, further embodiments of the vehicle may include that determining the dynamic aggregation duration includes setting a limit to the position offset.

In addition to one or more of the features described herein, or as an alternative, further embodiments of the vehicle may include that determining the dynamic aggregation duration includes deriving a limited aggregation time per reflection point based on the limit and depending on the radial velocity of the reflection point, the reflection point angle of the reflection point, and a heading direction distribution.

In addition to one or more of the features described herein, or as an alternative, further embodiments of the vehicle may include that determining the dynamic aggregation duration includes deriving the aggregation duration of each reflection point based on its limit.

In another embodiment a computer program product is provided. The computer program product includes a set of one or more computer-readable storage media and program instructions, collectively stored in the set of one or more storage media, for causing a processor set to perform computer operations. The operations include detecting, using a radar device of a vehicle, a reflection point on a target object, determining a dynamic aggregation duration for aggregating radar data for the reflection point, the dynamic aggregation duration being a period of time specific to the reflection point, wherein the dynamic aggregation duration is based at least in part on a radial velocity of the reflection point, a reflection point angle of the reflection point, and a distribution of a heading direction for the reflection point, aggregating the radar data, as aggregated radar data, of the target object for the period of time specific to the reflection point as defined by the dynamic aggregation duration, performing a perception task using the aggregated radar data of the target object aggregated for the period of time specific to the reflection point as defined by the dynamic aggregation duration, and autonomously driving the vehicle based at least in part on a result of the perception task.

In addition to one or more of the features described herein, or as an alternative, further embodiments of the computer program product may include that determining the dynamic aggregation duration includes determining a position offset, the position offset being an offset between a true position of the reflection point if shifted from a past point in time to a present point in time with a true velocity vector and the position of a predicted position of the reflection point when shifted according to the radial velocity of the reflection point, setting a limit to the position offset, deriving a limited aggregation time per reflection point based on the limit and depending on the radial velocity of the reflection point, the reflection point angle of the reflection point, and a heading direction distribution, and deriving the aggregation duration of each reflection point based on its limit.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a vehicle with a processing system and sensors according to one or more embodiments;

FIG. 2 illustrates the processing system of FIG. 1 according to one or more embodiments;

FIG. 3A illustrates a reflection point detected by the radar device of FIGS. 1 and 2 according to one or more embodiments;

FIG. 3B illustrates a reflection point detected by the radar device of FIGS. 1 and 2 according to one or more embodiments;

FIG. 4A illustrates a block diagram of a system for dynamic aggregation duration for a vehicle-based radar point cloud according to one or more embodiments;

FIG. 4B illustrates a block diagram of a system for dynamic aggregation duration for a vehicle-based radar point cloud according to one or more embodiments;

FIG. 5 depicts a flow diagram of a method for dynamic aggregation duration for a vehicle-based radar point cloud according to one or more embodiments; and

FIG. 6 illustrates a block diagram of a processing system for impedance balancing for a monitoring circuit of a battery of a vehicle according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein relates to dynamic aggregation duration for a vehicle-based radar point cloud.

Modern vehicle systems rely on advanced technologies to perform perception tasks, such as detecting, classifying, and tracking objects. These capabilities are useful for systems that enable accurate and efficient navigation, including semi-autonomous or autonomous operation of a vehicle, by understanding, in real-time, an environment of the vehicle. Challenges arise when data suffers from sparsity, leading to potential inaccuracies in detecting and estimating the shapes of dynamic objects.

In particular, radar systems in modern vehicles face challenges in accurately detecting and identifying objects due to the sparsity of radar point clouds. This sparsity arises from low angular resolution, which can lead to missed detections and inaccurate shape estimations of dynamic objects. The desire for precise object detection remains for applications, such as autonomous driving, where real-time awareness of the environment is important for safe navigation.

Existing approaches aim to improve data density through temporal aggregation. For example, radar data can be collected about a target object over time and aggregated to generate more data about the object than would otherwise be collected at a single point in time. Although this enhances density, temporal aggregation introduces complications, such as point spreading, especially for objects with unknown velocities. This spreading can affect the perceived position of objects, making accurate detection and tracking more difficult. Addressing the need for increased data density while minimizing point spreading remains a significant challenge in the field.

One or more embodiments described herein utilize a dynamic aggregation duration for radar point clouds, determined, for example, by the range, Doppler, and angle of reflection points relative to the vehicle. This approach minimizes point spreading while increasing point cloud density, thereby enhancing the accuracy of object detection and other perception tasks. By adjusting the aggregation duration based on the speed of reflection points, one or more embodiments effectively balances density and precision, providing enriched point clouds with reduced dispersion.

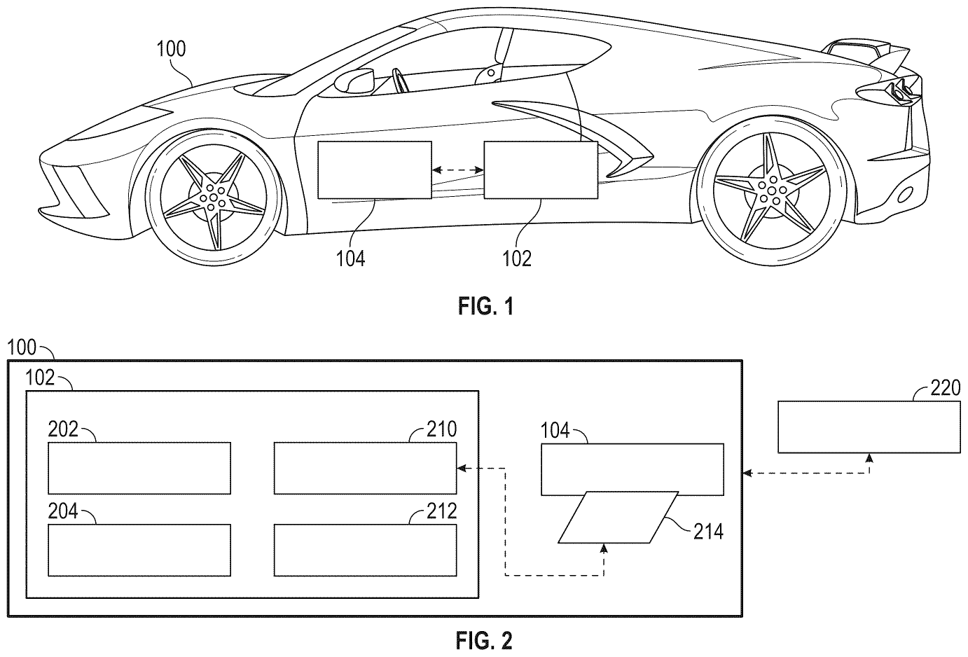

FIG. 1 shows a vehicle 100 with a processing system 102 and radar device 104 according to one or more embodiments. The vehicle 100 can be a car, a truck, a van, a bus, a motorcycle, a boat, or any other type of automobile. According to an embodiment, the vehicle 100 is a hybrid electric vehicle, such as a plug-in hybrid electric vehicle (PHEV) partially or wholly powered by electrical power. According to another embodiment, the vehicle 100 is an electric vehicle powered by electrical power. A battery (not shown) is used to provide electrical power to components of the vehicle 100, such as an electric motor (not shown), electrical components (not shown), and/or the like, including combinations and/or multiples thereof. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

The processing system 102 is located within the vehicle and is responsible for managing and processing data collected by the radar device 104. The radar device 104 is strategically positioned on the vehicle to gather data from the vehicle's environment. The arrows between the radar device 104 and the processing system 102 indicate the flow of data from the radar device 104 to the processing system 102, highlighting the interaction between these components. This setup enables the vehicle 100 to perform tasks perception tasks, which can be used for autonomous driving for example, using the data collected by the radar device 104.

Further features of the processing system 102 and the radar device 104 are now described with reference to FIG. 2.

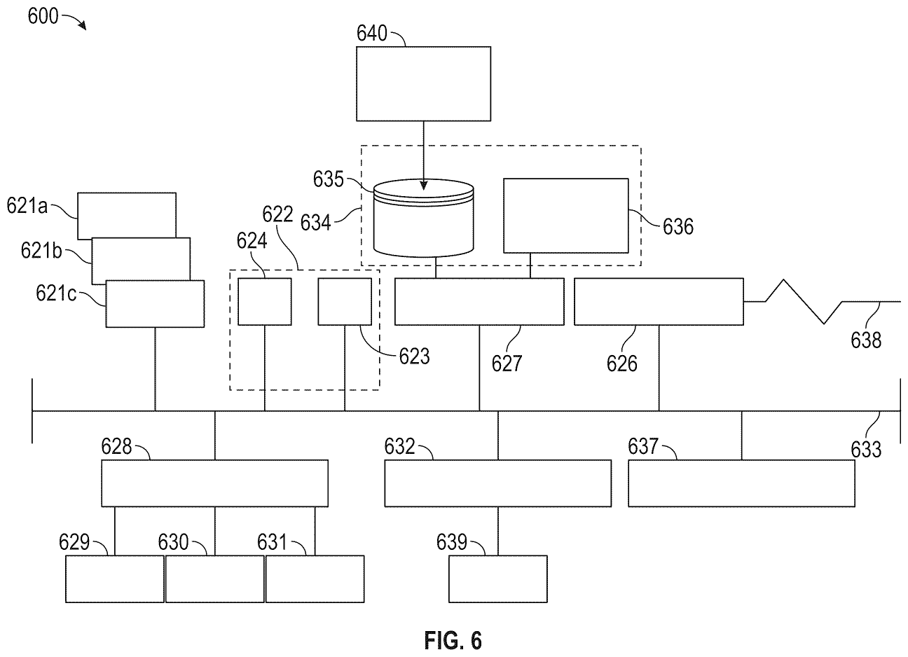

Particularly, FIG. 2 illustrates the processing system of FIG. 1 according to one or more embodiments. According to one or more embodiments, the processing system 102 includes a processing device 202, a memory 204, an aggregation duration engine 210, and a perception task engine 212. It should be appreciated that the processing system 102 can be any device suitable for performing or supporting infrastructure access control using vehicle-based lidar. For example, the processing system 102 can be a device implemented in or otherwise associated with the vehicle 100, such as an electronic control unit (also referred to as an electronic control module). As another example, the processing system 102 can be a smartphone, tablet computer, laptop computer, desktop computer, wearable computing device, and/or the like, including combinations and/or multiples thereof. As yet another example, the processing system 102 can be the processing system 600 of FIG. 6 and/or can include one or more components of the processing system 600 of FIG. 6.

The processing device 202 is responsible for executing instructions and managing the overall operation of the processing system 102. The processing device 202 can be any suitable processing circuitry for executing instructions and processing data. For example, the processing device 202 can be a microcontroller, microprocessor, application-specific integrated circuit (ASIC), or any other type of processing unit capable of handling the computational demands of the processing system 102. The processing device 202 is an example of one or more of the processing devices 621 of FIG. 6, as described in more detail herein.

The memory 204 stores data (e.g., radar data 214), computer-readable instructions, and algorithms useful for operation of the processing system 102. This may include real-time data processing, historical data analysis, and storage of firmware or software programs. The memory 204 is any suitable device for storing data, such as the radar data 214, and/or instructions. For example, the memory 204 can be a combination of volatile memory (e.g., random access memory) and non-volatile memory (e.g., read-only memory, flash memory). The memory 204 is an example of one or more of the system memory 622, the random access memory 623, and/or the read-only memory 624 of FIG. 6, as described in more detail herein.

The processing system 102 receives radar data 214 from the radar device 104 of objects, such as a target object 220, in an environment in which the vehicle 100 is operating. The radar data 214 is used to generate a point cloud, which is a discrete set of points in space. The point cloud acts as a digital representation of the environment, including the target object 220. The point cloud can be useful, for example, for performing perception tasks.

The aggregation duration engine 210 is responsible for dynamically adjusting the aggregation duration for collecting radar data 214 used to generate point clouds. It utilizes parameters, such as range, Doppler, and angle of reflection points, to determine an optimal aggregation time on a case-by-case basis. By doing so, the aggregation duration engine 210 minimizes point spreading, which is a common issue in temporal aggregation, especially for target object, such as the target object 220, with unknown velocities. The aggregation duration engine 210 ensures that the radar data 214 collected using the radar device 104 is dense enough to improve object detection accuracy while maintaining precision by reducing dispersion. The aggregation duration engine 210 allows for a more reliable perception of dynamic objects, enhancing the vehicle's overall sensing capabilities, by providing the ability to adapt the aggregation duration based on real-time data (e.g., the radar data 214).

The perception task engine 212 processes the radar data 214 to perform various perception tasks, such as object detection, classification, and tracking. It integrates the radar data 214 collected by the radar device 104 and processed by the aggregation duration engine 210 to provide real-time awareness of the environment of the vehicle 100, including the target object 220. The perception task engine 212 is useful for applications, such as autonomous driving, where accurate and timely perception is used for efficient and effective navigation. By leveraging advanced algorithms and processing techniques, the perception task engine 212 can interpret complex data sets, such as the radar data 214, enabling the vehicle 100 (or an operator of the vehicle 100) to make informed decisions. According to one or more embodiments, the perception task engine 212 enables the vehicle 100 to autonomously or semi-autonomously navigate through its environment with reduced need for manual intervention.

According to one or more embodiments, the perception task engine 212 can be used in combination with an autonomous driving system (not shown) to control autonomous navigation capabilities of the vehicle 100, allowing the vehicle 100 to navigate with respect to detected objects. According to one or more embodiments, the autonomous driving system processes information received from the perception task engine 212 and/or the radar data 214 received from the radar device 104 (e.g., the lidar device, camera devices, and GPS device) to determine the precise location and orientation of the vehicle 100. The autonomous driving system then generates control signals to steer, accelerate, or brake the vehicle as needed to safely and efficiently navigate. The autonomous driving system ensures that the vehicle 100 can autonomously perform complex maneuvers, reducing the need for manual intervention.

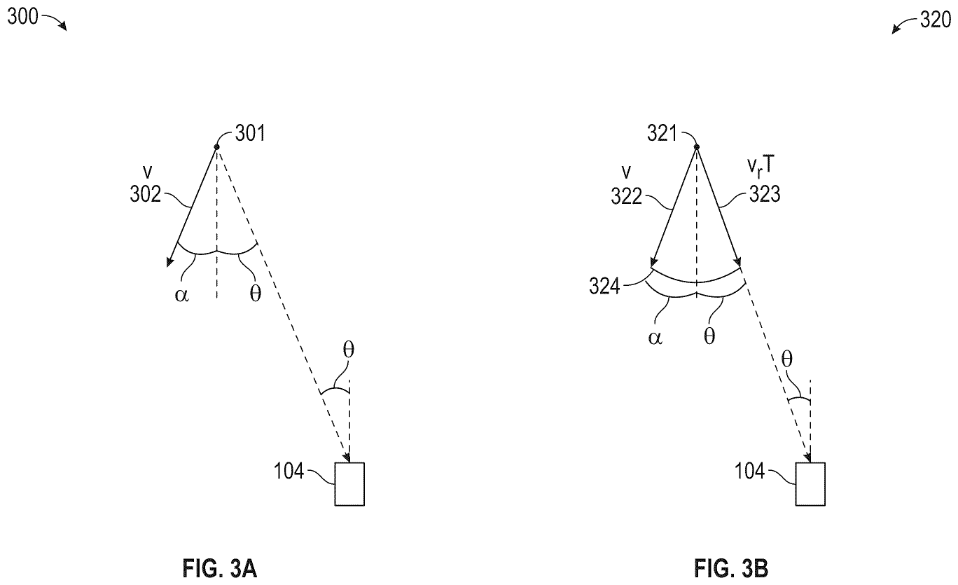

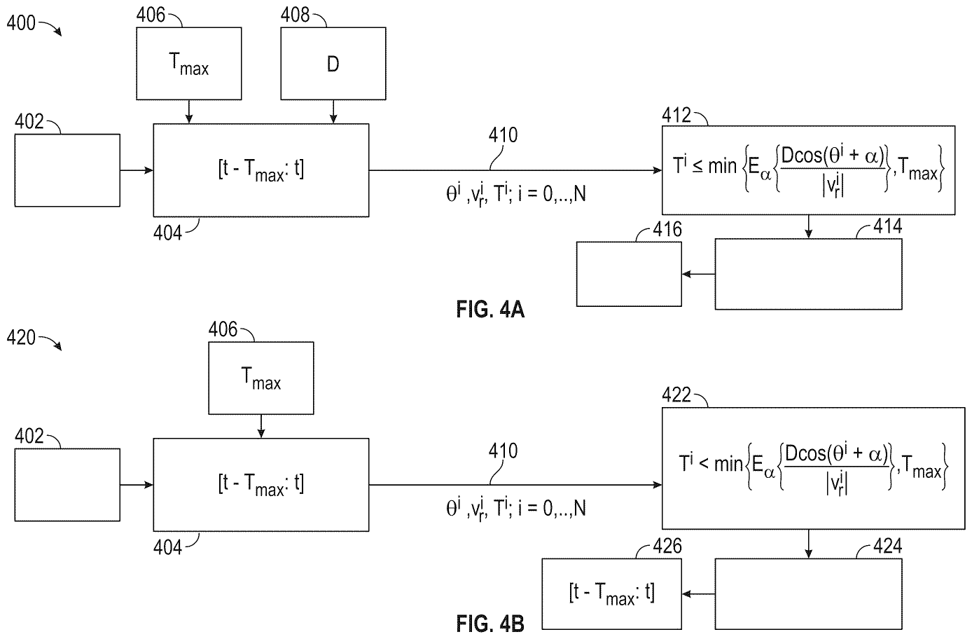

FIG. 3A illustrates a schematic representation 300 of a reflection point 301 detected by the radar device 104, as shown in FIG. 2. FIG. 3A is now described in more detail with reference to a system 400 as shown in FIG. 4. In particular, FIG. 4A depicts a block diagram of a system 400 for dynamic aggregation duration, which is part of the processing system 102 in FIG. 2.

The reflection point 301 is detected by the radar device 104. The reflection point 301 may be a point on the target object 220, for example, or another object within an environment of the vehicle 100. The reflection point has a motion vector with velocity v 302, which indicates the direction and magnitude of motion of the reflection point 301 relative to the radar device 104 (e.g., relative to the vehicle 100 that includes the radar device 104). More particularly, the motion vector with velocity v 302 represents a position offset for aggregation duration Tₘₐₓ. An angle θ and a heading α of the reflection point 301 used for deriving the velocity v of the reflection point 301 and the radial velocity vᵣ (Doppler) (not shown) of the reflection point 301. An aggregation time T is also defined, which is the duration for which the radar data 214 is collected. The radial velocity vᵣ is expressed as:

$${v}_{r} = v cos ( θ + α ) ,$$

and the velocity v can be derived using the radial velocity vᵣ as follows:

$$v = \frac{{v}_{r}}{cos ( θ + α )} .$$

These parameters are used by the aggregation duration engine 210 in FIG. 2 to dynamically adjust the aggregation duration, minimizing point spreading and enhancing object detection accuracy. Determining the aggregation duration is now described in more detail with reference to the system 400 of FIG. 4A.

With reference to FIG. 4A, the radar reflection points 402 are collected by the radar device 104 and are fed into block 404. At block 404, a time window defined by a maximal aggregation time Tₘₐₓ 406 and a maximal allowed offset D 408 are used to identify reflection points within the time window defined by the maximal aggregation time Tₘₐₓ 406 and for the maximal allowed offset D 408. That is, for aggregation up to time t, the reflection points (e.g., from the radar reflection points 402) within a time window defined by [t−Tₘₐₓ:t] are aggregated, resulting in output 410. The output 410 defines the detection points' angle θ, velocity vᵣ (Doppler), and time offset T from t as follows:

$${θ}^{i} , {v}_{r}^{i} , {T}^{i}$$

where i represents discrete times in the range [0 . . . N] during the time window defined by [t−Tₘₐₓ:t].

The aggregation duration engine 210 determines the dynamic aggregation duration. According to one or more embodiments, the dynamic aggregation duration is determined by determining a position offset, setting a limit (e.g., a maximum distance, such as 1 meter, 2 meters, etc.) to the position offset, deriving a limited aggregation time based on the limit, and deriving the dynamic aggregation duration based on the limited aggregation time. According to one or more embodiments, the dynamic aggregation duration is determined by using an average of the reflection point heading α. For example, the aggregation duration engine 210 applies a probability distribution for the reflection point heading α, such as a Laplacian distribution or other suitable distribution.

According to one or more embodiments, the position offset for the aggregation is calculated using the following equation:

$$\frac{{v}_{r} T}{cos ( θ + α )}$$

where vᵣ is a velocity of the reflection point 301, Tis an aggregation time, θ is a reflection point angle of the reflection point 301 relative to the radar device 104, and α is a reflection point heading of the reflection point 301 relative to the radar device 104.

According to one or more embodiments, the limit to the position offset is determined using the following equation:

$$\frac{\vert {v}_{r} \vert T}{cos ( θ + α )} < D$$

where vᵣ is a velocity of the reflection point, Tis an aggregation time, θ is a reflection point angle of the reflection point relative to the radar device, α is a reflection point heading of the reflection point relative to the radar device, and D is the limit.

According to one or more embodiments, the limited aggregation time is derived using the following equation:

$$T < \frac{D cos ( θ + α )}{\vert {v}_{r} \vert}$$

where vᵣ is a velocity of the reflection point, Tis an aggregation time, θ is a reflection point angle of the reflection point relative to the radar device, α is a reflection point heading of the reflection point relative to the radar device, and D is the limit.

According to one or more embodiments, the dynamic aggregation duration is derived using the following equation:

$$T < {E}_{α} \{ \frac{D cos ( θ + α )}{\vert {v}_{r} \vert} \} = {\int }_{α = - π / 2}^{π / 2} \frac{D cos ( θ + α )}{\vert {v}_{r} \vert} {p}_{r} ( α ) d α = \frac{D}{\vert {v}_{r} \vert} cos ( θ ) {L}_{1} - \frac{D}{\vert {v}_{r} \vert} sin ( θ ) {L}_{2}$$

where Tis an aggregation time, E_{α} is the expectation with respect to α, D is a limit to the position offset, θ is a reflection point angle of the reflection point relative to the radar device, α is a reflection point heading of the reflection point relative to the radar device, vᵣ is a velocity of the reflection point, pᵣ is a probability distribution function, L₁ is defined by the following equation:

$${L}_{1} = {\int }_{α = - π / 2}^{π / 2} cos ( α ) {p}_{r} ( α ) d α ,$$

and L₂ is defined by the following equation:

$${L}_{2} = {\int }_{α = - \frac{π}{2}}^{\frac{π}{2}} sin ( α ) {p}_{r} ( α ) d α .$$

At block 412, the radar device 104 collects points that satisfy the dynamic aggregation duration (e.g., points falling within the period defined by the dynamic aggregation duration). At block 414, the processing system 102 can perform processing on the collected points that satisfy the dynamic aggregation duration to compensate for motion, including ego-velocity (e.g., the velocity vector of the vehicle on which the radar device 104 is mounted (e.g., the vehicle 100)) and/or radial velocity, to produce an aggregated point cloud at block 416. This process is managed by the aggregation duration engine 210 and the perception task engine 212 in FIG. 2, ensuring accurate perception tasks are performed using the radar data 214.

According to one or more embodiments, dynamic aggregation duration can be used with range compensation to compensate for a range shift using Doppler. Such an embodiment is now described with reference to FIGS. 3B and 4B. Particularly, FIG. 3B illustrates a schematic representation 320 of a reflection point 321 detected by the radar device 104, as shown in FIG. 2. FIG. 3B is now described in more detail with reference to a system 420 as shown in FIG. 4. In particular, FIG. 4B depicts a block diagram of a system 420 for dynamic aggregation duration with range compensation, which is part of the processing system 102 in FIG. 2.

The reflection point 321 is detected by the radar device 104. The reflection point 321 may be a point on the target object 220, for example, or another object within an environment of the vehicle 100. The reflection point has a motion vector with velocity v 322, which indicates the direction and magnitude of motion of the reflection point 321 relative to the radar device 104 (e.g., relative to the vehicle 100 that includes the radar device 104). More particularly, the motion vector with velocity v 322 represents a position offset for aggregation duration T. An angle θ and a heading α of the reflection point 321 used for deriving the velocity v of the reflection point 321 and the radial velocity vᵣ (Doppler) of the reflection point 321. An aggregation time T is also defined, which is the duration for which the radar data 214 is collected. The radial velocity vᵣ is expressed as:

$${v}_{r} = v cos ( θ + α ) ,$$

and the velocity v can be derived using the radial velocity vᵣ as follows:

$$v = \frac{{v}_{r}}{cos ( θ + a )} .$$

The representation 320 also shows a vector that represents a compensation for radial shift by vᵣT 323 and an arc 324, which represents a difference between the motion vector with velocity v 322 and the compensation for radial shift by vᵣT 323.

These parameters are used by the aggregation duration engine 210 in FIG. 2 to dynamically adjust the aggregation duration, minimizing point spreading and enhancing object detection accuracy. Determining the aggregation duration is now described in more detail with reference to the system 420 of FIG. 4B.

At block 422, the aggregation duration engine 210 determines the dynamic aggregation duration. According to one or more embodiments, the dynamic aggregation duration is determined by determining a position offset, setting a limit (e.g., a maximum distance, such as 1 meter, 2 meters, etc.) to the position offset, deriving a limited aggregation time based on the limit, and deriving the dynamic aggregation duration based on the limited aggregation time. According to one or more embodiments, the dynamic aggregation duration is determined by using an average of the reflection point heading α. For example, the aggregation duration engine 210 applies a probability distribution for the reflection point heading α, such as a Laplacian distribution or other suitable distribution.

According to one or more embodiments, the position offset for the aggregation is calculated using the following equation:

$$\frac{{v}_{r} T}{cos ( θ + α )} sin ( θ + α ) = T {v}_{r} tan ( θ + α )$$

where vᵣ is a velocity of the reflection point, Tis an aggregation time, θ is a reflection point angle of the reflection point relative to the radar device, and α is a reflection point heading of the reflection point relative to the radar device.

According to one or more embodiments, the limit to the position offset is determined using the following equation:

$$T \vert {v}_{r} \vert tan ( θ + α ) < D$$

where vᵣ is a velocity of the reflection point, T is an aggregation time, θ is a reflection point angle of the reflection point relative to the radar device, α is a reflection point heading of the reflection point relative to the radar device, and D is the limit.

According to one or more embodiments, the limited aggregation time is derived using the following equation:

$$T < \frac{D}{\vert {v}_{r} \vert tan ( θ + α )}$$

where vᵣ is a velocity of the reflection point, T is an aggregation time, θ is a reflection point angle of the reflection point relative to the radar device, α is a reflection point heading of the reflection point relative to the radar device, and D is the limit.

According to one or more embodiments, the dynamic aggregation duration is derived using the following equation:

$$T < {E}_{α} \{ \frac{D}{\vert {v}_{r} \vert tan ( θ + α )} \} = {\int }_{α = - π / 2}^{π / 2} \frac{D}{\vert {v}_{r} \vert tan ( θ + α )} {p}_{r} ( α ) d α$$

where Tis an aggregation time, E_{α} is the expectation with respect to α, D is a limit to the position offset, θ is a reflection point angle of the reflection point relative to the radar device, α is a reflection point heading of the reflection point relative to the radar device, vᵣ is a velocity of the reflection point, and pᵣ is a probability distribution function

At block 422, the radar device 104 collects points that satisfy the dynamic aggregation duration (e.g., points falling within the period defined by the dynamic aggregation duration). At block 424, the processing system 102 can perform processing on the collected point that satisfy the dynamic aggregation duration to compensate for motion, including ego-velocity and/or radial velocity, to produce an aggregated point in the time window defined by [t−Tₘₐₓ:t] at block 426. This process is managed by the aggregation duration engine 210 and the perception task engine 212 in FIG. 2, ensuring accurate perception tasks are performed using the radar data 214.

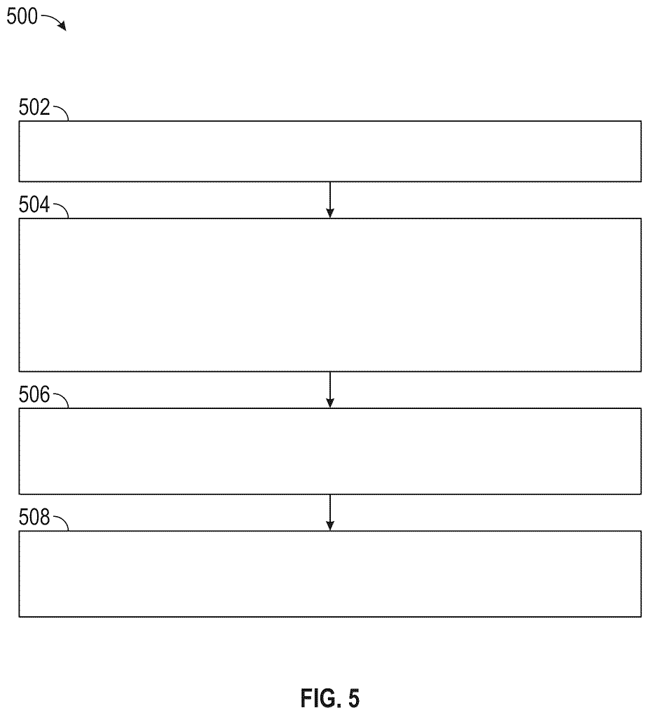

FIG. 5 illustrates a flow diagram of a method 500 for dynamic aggregation duration for a vehicle-based radar point cloud according to one or more embodiments. The method 500 can be implemented using any suitable system or device. For example, the method 500, and its steps, can be implemented using the processing system 102 of FIGS. 1 and 2, by the processing system 600 of FIG. 6, and/or the like, including combinations and/or multiples thereof. The method 500 is now described with reference to at least portions of FIGS. 1-4B but is not so limited.

At block 502, the method begins with detecting a reflection point (e.g., the reflection point 301) on a target object (e.g., the target object 220) using the radar device 104 of the vehicle 100, as shown in FIG. 2. The radar device 104 collects radar data 214, which is processed by the processing system 102.

At block 504, the dynamic aggregation duration is determined. The dynamic aggregation duration is used for aggregating radar data for the reflection point. The dynamic aggregation duration is a period of time specific to the reflection point and is based at least in part on a radial velocity of the reflection point, a reflection point angle of the reflection point, and a distribution of a heading direction for the reflection point. The dynamic aggregation duration optimizes data collection, thereby minimizing point spreading.

At block 506, the radar data of the target object is aggregated for the target object for the period of time specific to the reflection point as defined by the dynamic aggregation duration. As a result of the aggregation at block 506, aggregated radar data are generated.

Finally, at block 508, a perception task is performed using the aggregated radar data (e.g., the radar data 214 that is aggregated for the period defined by the dynamic aggregation duration). More particularly, a perception task is performed using the aggregated radar data of the target object aggregated for the period of time specific to the reflection point as defined by the dynamic aggregation duration. Perception tasks, as performed by the perception task engine 212, involve processing the radar data, collected during the dynamic aggregation duration, to detect, classify, and track objects in the environment of the vehicle 100, for example. These tasks are useful for providing real-time awareness, enabling the vehicle 100 to make informed decisions. For example, in autonomous driving, perception tasks help identify obstacles, road signs, and other vehicles, allowing for safe navigation. The perception task engine 212 integrates data collected by the radar device 104 and processed by the aggregation duration engine 210 to enhance the accuracy and reliability of these tasks.

According to one or more embodiments, the method 500 includes autonomously driving the vehicle based at least in part on a result of the perception task. Autonomously driving the vehicle 100 means that the vehicle 100 operates without human intervention (or with limited human interaction), using its systems to navigate and make driving decisions (e.g., make turns, merge, speed up, slow down, and/or the like, including combinations and/or multiples thereof). This involves using data from sensors, such as the radar device 104, to detect and respond to the environment of the vehicle 100, ensuring safe and efficient travel. The vehicle 100 can perform tasks like steering, accelerating, and braking based on real-time perception and analysis.

Additional processes also may be included, and it should be understood that the processes depicted in FIG. 5 represent illustrations, and that other processes may be added, or existing processes may be removed, modified, or rearranged without departing from the scope of the present disclosure. It should also be understood that the processes depicted in FIG. 5 may be implemented as programmatic instructions stored on a non-transitory computer-readable storage medium that, when executed by a processor (e.g., the processing device 202 of FIG. 2, the processor(s) 621 of FIG. 6, and/or the like, including combinations and/or multiples thereof) of a computing system (e.g., the processing system 102 of FIGS. 1 and 2, the processing system 600 of FIG. 6, and/or the like, including combinations and/or multiples thereof), cause the processor to perform the processes described herein.

One or more embodiments offer significant technical benefits, including enhanced accuracy in object detection by increasing radar point cloud density while minimizing point spreading. This improvement is achieved through dynamic aggregation duration, which adjusts the aggregation duration based on parameters, such as range, Doppler, and angle of a reflection point. By optimizing radar data collection, one or more embodiments provides enriched point clouds, leading to more reliable perception tasks. This is particularly beneficial for autonomous or semi-autonomous driving, where precise real-time awareness of the environment is crucial for safe navigation. These and other benefits may be possible in various embodiments as described herein.

It is understood that one or more embodiments described herein is capable of being implemented in conjunction with any other type of computing environment now known or later developed. For example, FIG. 6 depicts a block diagram of a processing system 600 for implementing the techniques described herein. In accordance with one or more embodiments described herein, the processing system 600 is an example of a cloud computing node of a cloud computing environment. In examples, processing system 600 has one or more central processing units (referred to also as “processors” or “processing resources” or “processing devices”) 621a, 621b, 621c, etc. (collectively or generically referred to as processor(s) 621 and/or as processing device(s) 621). In aspects of the present disclosure, each processor 621 can include a reduced instruction set computer (RISC) microprocessor. Processors 621 are coupled to a system memory 622 and/or various other components via a system bus 633. The system memory 622 can include one or more temporary and/or persistent memory devices, such as a random access memory (RAM) 623, a read-only memory (ROM) 624, and/or the like, including combinations and/or multiples thereof. The system bus 633 may include a basic input/output system (BIOS), which controls certain basic functions of processing system 600.

Further depicted are an input/output (I/O) adapter 627 and a network adapter 626 coupled to system bus 633. I/O adapter 627 may be a small computer system interface (SCSI) adapter that communicates with a hard disk 635 and/or a storage device 636 or any other similar component. I/O adapter 627, hard disk 635, and storage device 636 are collectively referred to herein as mass storage 634. Operating system 640 for execution on processing system 600 may be stored in mass storage 634. The network adapter 626 interconnects system bus 633 with an outside network 638 enabling processing system 600 to communicate with other such systems.

A display (e.g., a display monitor) 639 is connected to system bus 633 by display adapter 632, which may include a graphics adapter to improve the performance of graphics intensive applications and a video controller. In one aspect of the present disclosure, adapters 626, 627, and/or 632 may be connected to one or more I/O buses that are connected to system bus 633 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 633 via user interface adapter 628 and display adapter 632. A keyboard 629, mouse 630, and speaker 631 may be interconnected to system bus 633 via user interface adapter 628, which may include, for example, a Super I/O chip integrating multiple device adapters into a single integrated circuit.

In some aspects of the present disclosure, processing system 600 includes a graphics processing unit (GPU) 637. Graphics processing unit 637 is a specialized electronic circuit designed to manipulate and alter memory to accelerate the creation of images in a frame buffer intended for output to a display. In general, graphics processing unit 637 is very efficient at manipulating computer graphics and image processing and has a highly parallel structure that makes it more effective than general-purpose CPUs for algorithms where processing of large blocks of data is done in parallel.

Thus, as configured herein, processing system 600 includes processing capability in the form of processors 621, storage capability including the system memory 622 and mass storage 634, input means such as keyboard 625 and mouse 630, and output capability including speaker 631 and display 639. In some aspects of the present disclosure, a portion of system memory 622 and mass storage 634 collectively store the operating system 640 to coordinate the functions of the various components shown in processing system 600.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method comprising:
detecting, using a radar device of a vehicle, a reflection point on a target object;
determining a dynamic aggregation duration for aggregating radar data for the reflection point, the dynamic aggregation duration being a period of time specific to the reflection point, wherein the dynamic aggregation duration is based at least in part on a radial velocity of the reflection point, a reflection point angle of the reflection point, and a distribution of a heading direction for the reflection point;
aggregating the radar data, as aggregated radar data, of the target object for the period of time specific to the reflection point as defined by the dynamic aggregation duration; and
performing a perception task using the aggregated radar data of the target object aggregated for the period of time specific to the reflection point as defined by the dynamic aggregation duration.

2. The computer-implemented method of claim 1, further comprising autonomously driving the vehicle based at least in part on a result of the perception task.

3. The computer-implemented method of claim 1, wherein determining the dynamic aggregation duration comprises:
determining a position offset, the position offset being an offset between a true position of the reflection point if shifted from a past point in time to a present point in time with a true velocity vector and the position of a predicted position of the reflection point when shifted according to the radial velocity of the reflection point;
setting a limit to the position offset;
deriving a limited aggregation time per reflection point based on the limit and depending on the radial velocity of the reflection point, the reflection point angle of the reflection point, and a heading direction distribution; and
deriving the aggregation duration of each reflection point based on its limit.

4. The computer-implemented method of claim 3, wherein the dynamic aggregation duration is based on a Laplacian distribution, the Laplacian distribution being the heading direction distribution of the reflection point.

5. The computer-implemented method of claim 3, wherein the position offset is determined using the following equation:
$$\frac{{v}_{r} T}{cos ( θ + α )}$$
where vᵣ is a velocity of the reflection point, Tis an aggregation time, θ is a reflection point angle of the reflection point relative to the radar device, and α is a reflection point heading of the reflection point relative to the radar device.

6. The computer-implemented method of claim 3, wherein the position offset is determined using the following equation:
$$\frac{{v}_{r} T}{cos ( θ + α )} sin ( θ + α ) = T {v}_{r} tan ( θ + α )$$
where vᵣ is a velocity of the reflection point, T is an aggregation time, θ is a reflection point angle of the reflection point relative to the radar device, and α is a reflection point heading of the reflection point relative to the radar device.

7. The computer-implemented method of claim 3, wherein the limit to the position offset is determined using the following equation:
$$\frac{\vert {v}_{r} \vert T}{cos ( θ + α )} < D$$
where vᵣ is a velocity of the reflection point, T is an aggregation time, θ is a reflection point angle of the reflection point relative to the radar device, α is a reflection point heading of the reflection point relative to the radar device, and D is the limit.

8. The computer-implemented method of claim 3, wherein the limit to the position offset is determined using the following equation:
$$T \vert {v}_{r} \vert tan ( θ + α ) < D$$
where vᵣ is a velocity of the reflection point, T is an aggregation time, θ is a reflection point angle of the reflection point relative to the radar device, α is a reflection point heading of the reflection point relative to the radar device, and D is the limit.

9. The computer-implemented method of claim 3, wherein the limited aggregation time is derived using the following equation:
$$T < \frac{D cos ( θ + α )}{\vert {v}_{r} \vert}$$
where vᵣ is a velocity of the reflection point, T is an aggregation time, θ is a reflection point angle of the reflection point relative to the radar device, α is a reflection point heading of the reflection point relative to the radar device, and D is the limit.

10. The computer-implemented method of claim 3, wherein the limited aggregation time is derived using the following equation:
$$T < \frac{D}{\vert {v}_{r} \vert tan ( θ + α )}$$
where vᵣ is a velocity of the reflection point, T is an aggregation time, θ is a reflection point angle of the reflection point relative to the radar device, α is a reflection point heading of the reflection point relative to the radar device, and D is the limit.

11. The computer-implemented method of claim 3, wherein the dynamic aggregation duration is derived using the following equation:
$$T < {E}_{a} \{ \frac{D cos ( θ + α )}{\vert {v}_{r} \vert} \} = {\int }_{a = - π / 2}^{π / 2} \frac{D cos ( θ + a )}{\vert {v}_{r} \vert} {p}_{r} ( α ) d α = \frac{D}{\vert {v}_{r} \vert} cos ( θ ) {L}_{1} - \frac{D}{\vert {v}_{r} \vert} sin ( θ ) {L}_{2}$$
where T is an aggregation time, E_{α} is the expectation with respect to α, D is a limit to the position offset, θ is a reflection point angle of the reflection point relative to the radar device, α is a reflection point heading of the reflection point relative to the radar device, vᵣ is a velocity of the reflection point, pᵣ is a probability distribution function, L₁ is defined by the following equation:
$${L}_{1} = {\int }_{a = - π / 2}^{π / 2} cos ( α ) {p}_{r} ( α ) d α ,$$
and L₂ is defined by the following equation:
$${L}_{2} = {\int }_{α = \frac{π}{2}}^{\frac{π}{2}} sin ( α ) {p}_{r} ( α ) d α .$$

12. The computer-implemented method of claim 3, wherein the dynamic aggregation duration is derived using the following equation:
$$T < {E}_{a} \{ \frac{D}{\vert {v}_{r} \vert tan ( θ + a )} \} = {\int }_{a = - π / 2}^{π / 2} \frac{D}{\vert {v}_{r} \vert tan ( θ + a )} {p}_{r} ( α ) d α$$
where T is an aggregation time, E_{α} is the expectation with respect to α, D is a limit to the position offset, θ is a reflection point angle of the reflection point relative to the radar device, α is a reflection point heading of the reflection point relative to the radar device, vᵣ is a velocity of the reflection point, and pᵣ is a probability distribution function.

13. A vehicle comprising:
a radar device; and
a processing system comprising:
a memory comprising computer readable instructions; and
a processing device for executing the computer readable instructions, the computer readable instructions controlling the processing system to perform operations comprising:
detecting, using the radar device of the vehicle, a reflection point on a target object;
determining a dynamic aggregation duration for aggregating radar data for the reflection point, the dynamic aggregation duration being a period of time specific to the reflection point, wherein the dynamic aggregation duration is based at least in part on a radial velocity of the reflection point, a reflection point angle of the reflection point, and a distribution of a heading direction for the reflection point;
aggregating the radar data, as aggregated radar data, of the target object for the period of time specific to the reflection point as defined by the dynamic aggregation duration; and
performing a perception task using the aggregated radar data of the target object aggregated for the period of time specific to the reflection point as defined by the dynamic aggregation duration.

14. The vehicle of claim 13, the operations further comprising autonomously driving the vehicle based at least in part on a result of the perception task.

15. The vehicle of claim 13, wherein determining the dynamic aggregation duration comprises determining a position offset, the position offset being an offset between a true position of the reflection point if shifted from a past point in time to a present point in time with a true velocity vector and the position of a predicted position of the reflection point when shifted according to the radial velocity of the reflection point.

16. The vehicle of claim 15, wherein determining the dynamic aggregation duration comprises setting a limit to the position offset.

17. The vehicle of claim 16, wherein determining the dynamic aggregation duration comprises deriving a limited aggregation time per reflection point based on the limit and depending on the radial velocity of the reflection point, the reflection point angle of the reflection point, and a heading direction distribution.

18. The vehicle of claim 17, wherein determining the dynamic aggregation duration comprises deriving the aggregation duration of each reflection point based on its limit.

19. A computer program product comprising:
a set of one or more computer-readable storage media;
program instructions, collectively stored in the set of one or more storage media, for causing a processor set to perform computer operations comprising:
detecting, using a radar device of a vehicle, a reflection point on a target object;
determining a dynamic aggregation duration for aggregating radar data for the reflection point, the dynamic aggregation duration being a period of time specific to the reflection point, wherein the dynamic aggregation duration is based at least in part on a radial velocity of the reflection point, a reflection point angle of the reflection point, and a distribution of a heading direction for the reflection point;
aggregating the radar data, as aggregated radar data, of the target object for the period of time specific to the reflection point as defined by the dynamic aggregation duration;
performing a perception task using the aggregated radar data of the target object aggregated for the period of time specific to the reflection point as defined by the dynamic aggregation duration; and
autonomously driving the vehicle based at least in part on a result of the perception task.

20. The computer program product of claim 1, wherein determining the dynamic aggregation duration comprises:
determining a position offset, the position offset being an offset between a true position of the reflection point if shifted from a past point in time to a present point in time with a true velocity vector and the position of a predicted position of the reflection point when shifted according to the radial velocity of the reflection point;
setting a limit to the position offset;
deriving a limited aggregation time per reflection point based on the limit and depending on the radial velocity of the reflection point, the reflection point angle of the reflection point, and a heading direction distribution; and
deriving the aggregation duration of each reflection point based on its limit.
